(19) United States
(12) Patent Application Publication
(10) Pub. No.: US 2026/0225801 A1
(43) Pub. Date: Aug. 6, 2026

(54) SYSTEMS AND METHODS FOR CATCHING AND REMOVING PALLETS AT PALLET STORAGE SLOTS

(71) Applicant: Walmart Apollo, LLC, Bentonville, AR (US)

(72) Inventors: Ted M. Lezak, Sterling, IL (US); Brian L. Asbury, Jr., Sterling, IL (US)

(21) Appl. No.: 19/465,724

(22) Filed: Jan. 30, 2026

Related U.S. Application Data
(60) Provisional application No. 63/752,227, filed on Jan. 31, 2025.

(51) Int. Cl. B65G 1/04

(52) U.S. Cl. CPC B65G 1/04

(57) ABSTRACT

Systems, apparatuses, and methods are provided for facilitating removal of pallets from a pallet storage slot. In some embodiments, at least one pallet stop is coupled to at least one pallet support rail of the pallet storage slot. The pallet stop includes a plate having an upwardly-facing surface that supports a downwardly-facing surface of a pallet, a fixed stopper non-detachably coupled to the plate and extending upwardly therefrom to restrict movement of the pallet in a direction of removal, and at least one wheel rotatably coupled relative to the plate. During removal of the pallet from a pallet storage slot, the pallet stop permits the pallet to be lifted such that the downwardly-facing surface clears a top edge of the fixed stopper, placed onto the at least one wheel, and moved in the direction of removal while the at least one wheel supports the pallet and rotates.

### CROSS-REFERENCE TO RELATED APPLICATIONS

This application claims the benefit of U.S. Provisional Application No. 63/752,227, filed January 31, 2025, which is incorporated herein by reference in its entirety.

### BACKGROUND

Pallet storage systems are widely used in retail facilities, distribution centers, and order fulfillment environments to store and stage pallets at elevated storage locations. Such pallet storage slots typically include one or more pallet support rails that support a pallet above the floor and may include pallet stops intended to prevent pallets from unintentionally sliding or falling out of the storage slot. Conventionally, pallets stored at elevated heights are often heavy and awkward to handle, and removal of pallets from conventional storage slots may require workers to lift, tilt, or otherwise manipulate the pallet while overcoming frictional resistance and catch points created by conventional pallet stops or rail structures. These factors can increase the physical effort required to remove a pallet and may elevate the risk of worker strain or injury.

### BRIEF DESCRIPTION OF DRAWINGS

Various examples will be described below with reference to the following figures:

FIG. 1 is a perspective view of an example pallet stop configured to catch a pallet and facilitate removal of the pallet from a pallet storage slot, in accordance with some embodiments;

FIG. 2 is a front view of the pallet stop of FIG. 1 illustrating multiple wheels arranged to support a pallet, in accordance with some embodiments

FIG. 3 is a rear view of the pallet stop of FIG. 1 illustrating a fixed stopper and plate structure, in accordance with some embodiments;

FIG. 4 is a perspective view of a pallet stop coupled to a pallet support rail of a pallet storage slot, in accordance with some embodiments;

FIG. 5 is a side view of a pallet positioned on pallet support rails and engaged with pallet stops at a pallet storage slot, in accordance with some embodiments;

FIG. 6 is a side view illustrating a pallet in a resting position on a pallet stop, in accordance with some embodiments;

FIG. 7 is a side view illustrating the pallet of FIG. 6 being lifted to clear a fixed stopper of the pallet stop, in accordance with some embodiments;

FIG. 8 is a side view illustrating the pallet of FIG. 7 positioned on one or more wheels of the pallet stop, in accordance with some embodiments;

FIG. 9 is a side view illustrating the pallet of FIG. 8 partially removed from the pallet storage slot, in accordance with some embodiments;

FIG. 10 is a side view illustrating the pallet of FIG. 9 further removed from the pallet storage slot, in accordance with some embodiments;

FIG. 11 is a front view of another example pallet stop having a single roller wheel, in accordance with some embodiments;

FIG. 12 is a perspective view of the pallet stop of FIG. 11 illustrating a housing structure and fixed stopper, in accordance with some embodiments; and

FIG. 13 is a flow diagram illustrating an example method for removing a pallet from a pallet storage slot using a pallet stop, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Although certain actions and/or steps may be described or depicted in a particular order of occurrence, those actions and/or steps are not limited to that order and may be performed in a different order or occurrence. The terms and expressions used herein have the ordinary technical meaning as is accorded to such terms and expressions except where different specific meanings have otherwise been set forth herein.

### DETAILED DESCRIPTION

Generally speaking, pursuant to various embodiments, systems, apparatuses, and methods are provided herein useful to facilitating removal of pallets from a pallet storage slot. In some embodiments, an apparatus for facilitating removal of pallets from a pallet storage slot includes at least one pallet stop coupled to at least one pallet support rail of the pallet storage slot. The at least one pallet stop includes a plate including an upwardly-facing surface that supports a downwardly-facing surface of a pallet stored in the pallet storage slot thereon, a fixed stopper non-detachably coupled to the plate and extending upwardly therefrom. The fixed stopper restricts the pallet from moving in a direction of removal of the pallet from the pallet storage slot. At least one wheel is rotatably coupled relative to the plate and rotates in the direction of removal of the pallet from the pallet storage slot. During removal of the pallet from the pallet storage slot, the at least one pallet stop permits the downwardly-facing surface of the pallet to be lifted therefrom until the downwardly-facing surface of the pallet is above a top edge of the fixed stopper, and placed onto the at least one wheel and moved in the direction of removal of the pallet from the pallet storage slot while the at least one wheel supports the downwardly-facing surface of the pallet thereon and rotates in the direction of removal of the pallet from the pallet storage slot.

The following description is not to be taken in a limiting sense, but is made merely for the purpose of describing the general principles of example embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

In some embodiments, a method of removing pallets from a pallet storage slot includes supporting a downwardly-facing surface of a pallet on an upwardly-facing surface of a plate of at least one pallet stop while catching, by a fixed stopper of the at least one pallet stop, a pallet to restrict the pallet from moving in the direction of removal of the pallet from the pallet storage slot, wherein the least one pallet stop is coupled to at least one pallet support rail of the pallet storage slot, the at least one pallet stop including: the plate; the fixed stopper non-detachably coupled to the plate and extending upwardly therefrom; and the at least one wheel that is rotatably coupled relative to the plate and that rotates in a direction of removal of the pallet from the pallet storage slot; lifting a front edge of the pallet from the upwardly-facing surface of the plate until the downwardly-facing surface of the pallet is above a top edge of the fixed stopper; placing the downwardly-facing surface of the pallet onto the at least one wheel; and moving the pallet in the direction of removal of the pallet from the pallet storage slot while the at least one wheel supports the downwardly-facing surface of the pallet thereon.

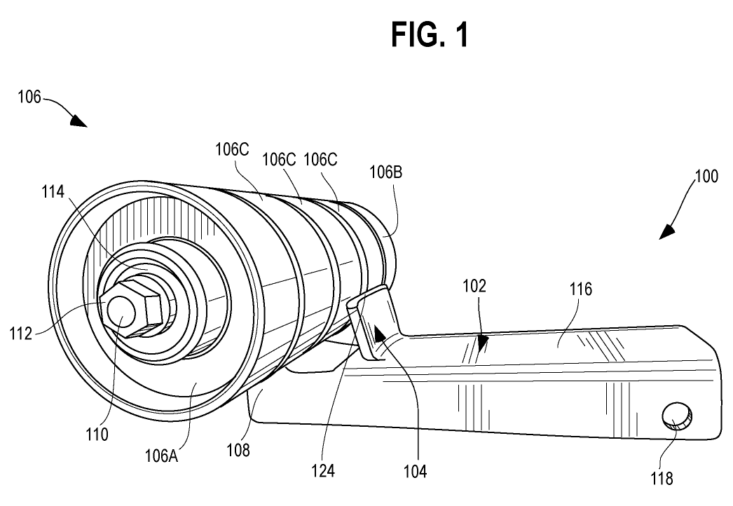

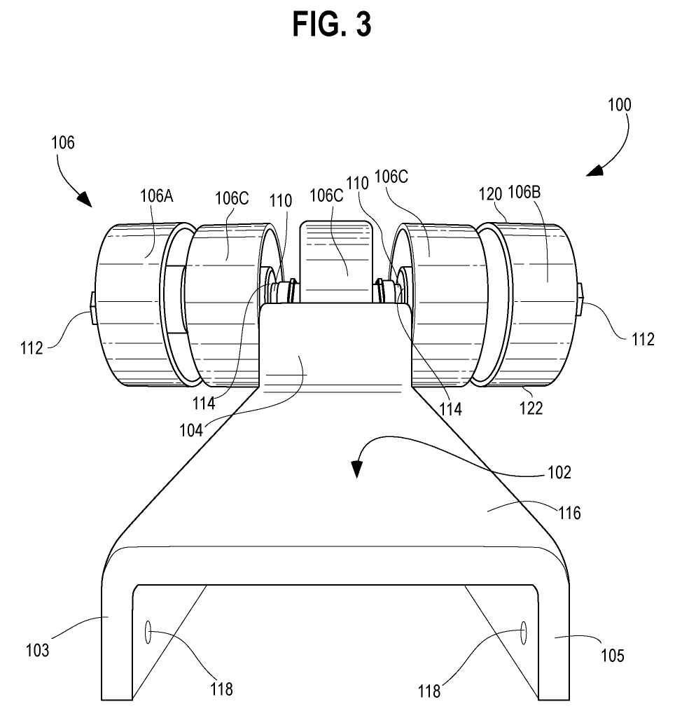

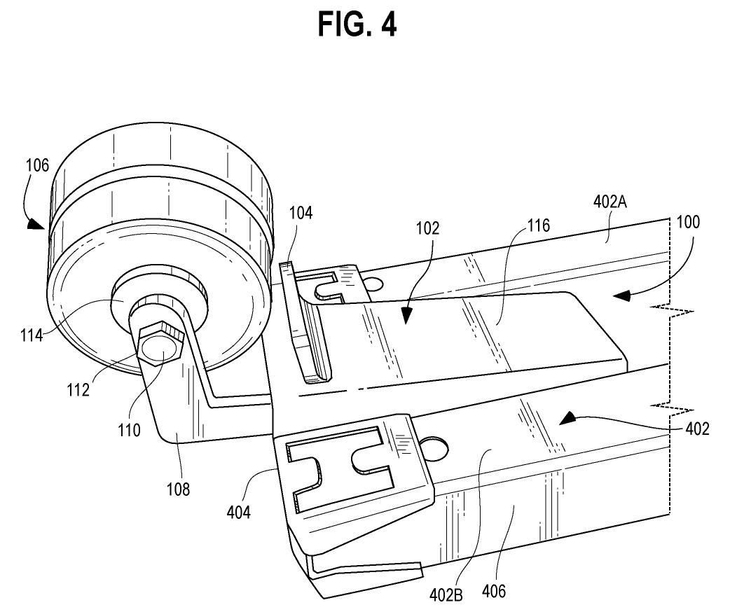

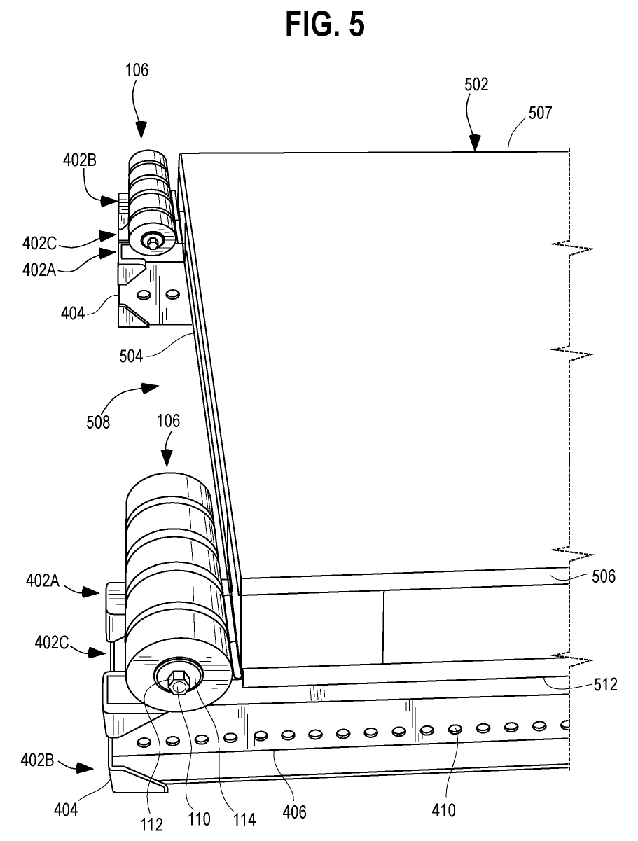

FIGS. 1-3 illustrate an example embodiment of a pallet stop 100 that catches pallets stored in a pallet storage slot and restricts their directional movement, and to also facilitate removal of the pallets from the pallet storage slot, such as the example pallet storage slot 508 depicted in FIG. 5. Generally, a pallet stop 100 and/or a pallet storage slot 508 may be found within a retail facility. The retail facility may include order fulfillment centers, distribution centers, retail centers, consolidation centers, and/or any alternate facility that may use pallets. In some embodiments, other items that may reside in a pallet storage slot 508 within a retail facility may be used in place of a pallet, such as boxes, totes, crates, containers, etc. The example pallet stop 100 shown in FIG. 1 includes a plate 102, a fixed stopper 104, and at least one wheel 106. Generally, one or more such pallet stops 100 may be coupled with one or more pallet support rails, such as the example pallet support rail 402 shown in FIG. 4. The pallet stop 100 may be made of any combination of materials including metals, plastics, silicones, rubber, wood, etc.

In some embodiments, the pallet stop 100 may be used to catch a pallet, such as a pallet 502 shown in FIG. 5, and/or prevent the pallet 502 from being displaced from (e.g., directionally sliding, falling out of, etc.) the pallet storage slot 508. In some embodiments, a pallet storage slot 508 contains at least one pallet support rail 402. In the embodiment illustrated in FIG. 5, the pallet storage slot 508 includes two pallet support rails 402, each of which includes a first rail 402A and a second rail 402B and supports a portion of the pallet 502 thereon. Notably, while the example pallet stop 100 illustrated in FIGS. 1-3 includes five wheels 106A-106C, the example pallet stop 100 illustrated in FIG. 4 includes only two wheels 106. In some embodiments, the pallet storage slot 508 and pallet support rails 402 are oriented at a downward gradient in the direction of travel of the pallet 502 when the pallet 502 is being removed from the pallet storage slot 508. In other words, in some embodiments, a front end 404 of the pallet support rail 402 is lower (i.e., located below along a vertical axis) than a rear end (not shown) of the pallet support rail 402.

The pallet stop 100 generally acts as a catch mechanism that both retains a pallet 502 in place and facilitates the removal of the pallet 502 from the pallet storage slot 508 with minimal friction and catch points. Notably, the wheels 106 of the pallet stop 100 improve safety of a worker during the removal of the pallet 502 from the pallet storage slot 508, since the rotation of the wheels 106, which support a portion of the pallet 502 during the removal of the pallet 502 from the pallet storage slot 508, minimizes the amount of force the worker needs to remove a pallet 502 from the pallet storage slot 508, and the reduction of catch points additionally improves safety. During removal of the pallet 502 from the pallet storage slot 508, the pallet stop 100 permits the downwardly-facing surface 512 of the pallet 502 to be lifted from a pallet support rail 402 of the pallet storage slot 508 until the downwardly-facing surface 512 of the pallet 502 clears (i.e., is located above) a top edge 124 of the fixed stopper 104 of the pallet stop 100, and is placed onto the wheels 106 of the pallet stop 100. Once the downwardly-facing surface 512 of the pallet 502 is placed onto the wheels 106 of the pallet stop 100, the pallet 502 may be moved in the direction of removal of the pallet 502 from the pallet storage slot 508 while the wheels 106 support the downwardly-facing surface 512 of the pallet 502 and rotate in the direction of removal of the pallet 502 from the pallet storage slot 508. As used herein, the ‘direction of removal’ is the direction from the pallet storage slot 508 toward the worker during the extraction of the pallet 502 from the pallet storage slot 508.

In some embodiments, the plate 102 of the pallet stop 100 includes an upwardly-facing surface 116 configured to support a downwardly-facing surface 512 of a pallet 502 stored within the pallet storage slot 508. While in the catch or rest position prior to removal from the pallet storage slot 508, at least a part of the downwardly-facing surface 512 of the pallet 502 may be disposed on the upwardly-facing surface 116 of the plate 102. In some embodiments, the plate 102 of the pallet stop 100 is non-detachably coupled with the pallet support rail 402 (e.g., via welding, or another suitable means). In some embodiments, the plate 102 of the pallet stop 100 is non-detachably coupled with the pallet support rail 402 (e.g., via a bolt or another fastener) such that the plate 102 may be removable from the pallet support rail 402 but is intended not to be removed from the pallet support rail 402. In alternate embodiments, the plate 102 of the pallet stop 100 may be detachably coupled to the pallet support rail 402 and is intended to be removable from the pallet support rail 402.

In some embodiments, the pallet stop 100 includes a first side wall 103 extending downwardly from the plate 102 and a second side wall 105 extending opposite (e.g., in parallel) to the first side wall 103 and downwardly from the plate 102. Each of the first side wall 103 and the second side wall 105 may include an aperture 118 that permits the first side wall 103 and the second side wall 105 to be fixedly attached to a pallet support rail 402 of a pallet storage slot 508. The aperture 118 may be a hole configured to allow a screw or bolt to attach the first side wall 103 and the second side wall 105 to a pallet support rail 402, but the aperture 118 may alternately be any other configuration for attaching the pallet stop 100 to the pallet support rail 402. The pallet stop 100 may be fixed to a pallet support rail 402 via the aperture 118 and/or by any alternate suitable means. The first side wall 103 and the second side wall 105 may be formed integrally with the plate 102 of the pallet stop 100 such that the plate 102, the first side wall 103, and the second side wall 105 form a single unitary structure having the upwardly-facing surface 116. Alternatively, the first side wall 103 and/or the second side wall 105 may be additional components fixed to the plate 102 of the pallet stop 100 by any suitable means.

In some embodiments, the fixed stopper 104 of the pallet stop 100 is non-detachably coupled with the plate 102 of the pallet stop 100 and extends upwardly from the upwardly-facing surface 116 of the plate 102. The fixed stopper 104 of the pallet stop 100 is configured to restrict a pallet 502 from unintentionally/inadvertently moving (e.g., sliding) in a direction of removal of the pallet 502 from the pallet storage slot 508, until the pallet 502 is intentionally removed from the pallet storage slot 508 by the worker. In some embodiments, the fixed stopper 104 is oriented perpendicularly relative to the upwardly-facing surface 116 of the plate 102. Notably, the fixed stopper 104 may be angled such that the fixed stopper 104 is not perpendicular to the upwardly-facing surface 116 of the plate 102. In some aspects, the fixed stopper 104 may be generally flat (i.e., planar) and positioned at an angle (90 degrees, less than 90 degrees, or more than 90 degrees) relative to the plate 102. Alternately, the fixed stopper 104 may be curved and may be oriented at multiple angles relative to the upwardly-facing surface of the plate 102. Any combination of angles, shapes, configurations, and/or curvatures of the fixed stopper 104 relative to the plate 102 which allows the fixed stopper 104 to catch the pallet 502 and restrict directional movement of the pallet 502 from the pallet storage slot 508 and/or which facilitates the removal of a pallet 502 from a pallet storage slot 508 may be used. The fixed stopper 104 may include any combination of materials including metals, plastics, silicones, rubber, wood, etc. The fixed stopper 104 may be fixed to the plate 102 by a plurality of means including soldering, fasteners, etc., and/or by being formed integrally with the plate 102.

In some embodiments, the wheels 106 of the pallet stop 100 are rotatably coupled relative to the pallet 502 and configured to rotate in the direction of removal of the pallet 502 from the pallet storage slot 508. In some embodiments, the wheels 106 of the pallet stop 100 are directly coupled to the plate 102, while in alternate embodiments an additional intermediate structure extends from the plate 102 and the wheels 106 are indirectly mounted to the plate 102 of the pallet stop 100 coupling to the intermediate structure (such as the arm 108 shown in FIG. 1 and described below). In some embodiments, at least one of the wheels 106 is a caster wheel, while in alternate embodiments each of the wheels 106 may be any wheel suitable for facilitating the removal of a pallet 502 from a pallet storage slot 508. The wheels 106 of the pallet stop 100 may include any combination of materials including, steel, aluminum, chrome, alloy, forged, rubber, silicones, plastics, etc., which allow a pallet 502 to be placed on the wheels 106 during the removal of the pallet 502 from the pallet storage slot 508.

In some embodiments, the wheels 106 are made of material having a coefficient of friction that allows for minimal slippage of the pallet 502 on the wheels 106. Generally, the wheels 106 are positioned relative to the plate 102 such that a top surface 120 of each of the wheels 106 is higher than a top edge 124 of the fixed stopper 104 relative to the upwardly-facing surface 116 of the plate 102. In other words, in some aspects, a distance along a vertical axis from the upwardly-facing surface 116 to the top surface 120 of each of the wheels 106 is greater than a distance along the vertical axis from the upwardly-facing surface 116 to the top edge 124. In alternate embodiments, however, the top edge 124 of the fixed stopper 104 may be the same height as and/or taller than the top surface 120 of each of the wheels 106. In some embodiments, the wheels 106 are permitted to rotate in the direction of removal of a pallet 502 from a pallet storage slot 508 and in the opposite direction, while in alternate embodiments, a physical stopper or restraint may prevent the wheels 106 from rotating in the direction opposite of the direction of removal of a pallet 502 from a pallet storage slot 508.

In some embodiments, the pallet stop 100 includes three or more wheels 106, including: a first end wheel 106A, a second end wheel 106B, and one or more middle wheels 106C disposed between the first end wheel 106A and the second end wheel 106B. In some embodiments, each of the wheels 106A-106C includes a bearing 114, and the bearing 114 of each of the wheels 106A-106C is coupled with the bearing 114 of at least one adjacent wheel 106A-106C. Generally, each of the wheels 106A-106C includes a first side and a second side, and each of the middle wheels 106C is coupled by a respective bearing 114 to an adjacent wheel 106A-106C on both the first side and the second side. For example, the first end wheel 106A may be coupled by the respective bearing 114 to a first wheel of the one or more middle wheels 106C on the respective first side, and the second end wheel 106B may be coupled by the respective bearing 114 to the first wheel and/or a second wheel of the one or more middle wheels 106C on the respective second side.

In the embodiment depicted in FIGS. 1-3, the pallet stop 100 includes five wheels 106 (i.e., a first end wheel 106A, a second end wheel 106B and three middle wheels 106C disposed between the first end wheel 106A and the second end wheel 106B). In some embodiments, each wheel 106 of the five wheels 106A-106C includes a bearing 114 such that each bearing 114 of each wheel 106 of the five wheels 106A-106C is coupled with the bearing 114 of at least one adjacent wheel 106 of the five wheels 106A-106C. It is understood that in embodiments with three or more wheels 106, there may be any alternate number or configuration of wheels 106 such that the first end wheel 106A and the second end wheel 106B are coupled on one side to an adjacent wheel 106 by the respective bearings 114, and such that one or more middle wheels 106C are coupled on both sides to adjacent wheels 106 by the respective bearings 114. Generally, the wheels 106 are identical in size and are oriented such that the top surfaces 120 of the wheels 106 are co-linear to one another and such that the bottom surfaces 122 of the wheels 106 are co-linear to one another. The wheels 106 may include any combination of amount, size, and/or alignment with one another for facilitating the removal of a pallet 502 from a pallet storage slot 508.

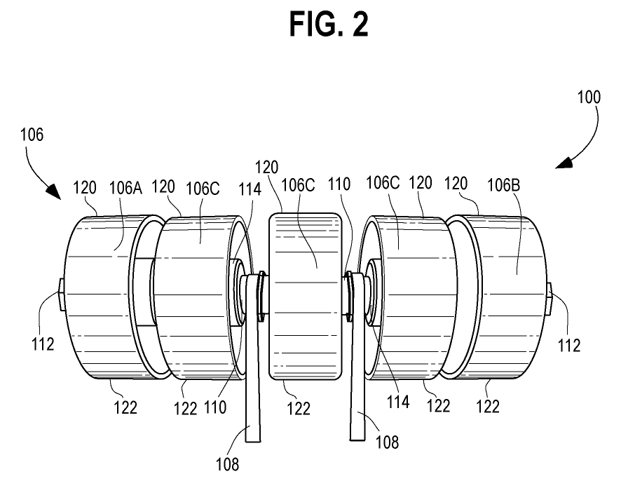

In some embodiments, the pallet stop 100 further includes at least one arm 108 coupled to and extending outwards from the plate 102 and coupled to one or more wheels 106. In some embodiments, the arm 108 of the pallet stop 100 extends in a direction that is substantially parallel to the direction of removal of the pallet 502 from the pallet storage slot 508. The arms 108 of the pallet stop 100 may, however, extend in any direction and/or with any length of the arms 108 which facilitates the removal of a pallet 502 from a pallet storage slot 508. In the example embodiment depicted in FIG. 2, the pallet stop 100 includes two arms 108 located forwardly relative to the fixed stopper 104 that extend with a steep, though non-perpendicular, angle relative to the upwardly-facing surface 116 of the plate 102. Generally, in example embodiments, the wheels 106 of the pallet stop 100 are positioned proximately (e.g., spaced away by a distance that is less than a diameter of a wheel 106) to the top edge 124 of the fixed stopper 104 such that during removal of a pallet 502 from the pallet storage slot 508, the pallet 502 may be easily lifted up and over the fixed stopper 104 and onto the wheels 106.

Without wishing to be limited by theory, positioning the wheels 106 of the pallet stop 100 proximately to the fixed stopper 104 of the pallet stop 100 reduces the chances that the pallet 502 may get caught between the wheels 106 and the fixed stopper 104 during the removal of the pallet 502 from the pallet storage slot 508, and facilitates a smooth transition of the pallet 502 from the resting position on top of the pallet stop 100 to the position where the pallet 502 is lifted off the pallet stop 100 and fully removed from the pallet storage slot 508. In the example embodiment illustrated in FIG. 2, two arms 108 extend between the three middle wheels 106C to either side of a center wheel of the middle wheels 106C such that the bearings 114 on either side of the center wheel of the middle wheels 106C are contacting an arm 108. The other two middle wheels 106C further contact the other side of the arms 108 by their respective bearings 114. The center wheel of the middle wheels 106C contacts an arm 108 at each bearing 114, and each of the other middle wheels 106C contacts an arm 108 at one bearing 114 and the bearing 114 of an adjacent end wheel (either the first end wheel 106A or the second end wheel 106B) at the other bearing 114.

In some embodiments, a rod 110 is further coupled with the arms 108 of the pallet stop 100. In some embodiments, the arms 108 of the pallet stop 100 are coupled with the rod 110 by welding or any suitable alternate mechanisms that fixes the rod 110 to the arms 108. In alternate embodiments, the arms 108 of the pallet stop 100 may be coupled with the rod 110 such that the rod 110 extends through an opening in the arms 108 and is fixed to prevent movement of the arms 108 relative to the rod 110. The wheels 106 of the pallet stop 100 may be similarly mounted about the rod 110 such that the rod 110 extends through an opening in the center of a wheel 106 and a respective bearing 114, allowing for rotation of the wheels 106 about an axis of rotation that is generally the same as the rod 110. The bearings 114 of each wheel 106 may be fixed to the rod 110 such that there is no rotation of the bearings 114, but such that there is rotation of each wheel 106.

The rod 110 may extend in a direction that is substantially perpendicular to the direction of removal of the pallet 502 from the pallet storage slot 508, and the wheels 106 may be configured to rotate about the rod 110 in the direction of removal of the pallet 502 from the pallet storage slot 508. The rod 110 is generally stationary and includes any combination of materials that allows the wheels 106 to rotate freely about the rod 110 with minimal friction. Further, the wheels 106 may include their respective bearings 114 non-rotatably fixed to the rod 110 which allows the bearing 114 to remain stationary relative to the rod 110 while the at least one wheel 106 rotates relative to the rod 110. In alternate embodiments, the rod 110 may be rotatable rather than fixed. There may be any combination of wheels 106 and bearings 114 about the rod 110 in any combination of fixed and/or rotatable that is able to facilitate the removal of a pallet 502 from a pallet storage slot 508. The arms 108, the bearings 114, and any alternate components of the pallet stop 100 that may be unmovably fixed to the rod 110 may be fixed by any suitable means including welding, force from adjacent components, bolts, etc. In some embodiments, one or more connectors 112 are disposed on opposite ends of the rod 110, and the connectors 112 are configured to limit movement of the wheels 106 about the rod 110 to rotational movement. In other words, the connectors 112 restrict the movement of the wheels 106 in a direction along the length of the rod 110. The connectors 112 may be any suitable bolt, nut, screw, and/or alternate mechanical connector suitable for fixing the wheels 106 of the pallet stop 100 to the rod 110 to prevent movement other than rotation.

FIGS. 4-5 illustrate a pallet stop 100 coupled with a pallet support rail 402 of the pallet storage slot 508. In some embodiments, the plate 102 is non-detachably coupled with at least one pallet support rail 402, such that the plate 102 is unable/not intended to be uncoupled from the pallet support rail 402. In some embodiments, the aperture 118 of the plate 102 is aligned with an aperture 410 of the pallet support rail 402 and the plate 102 is attached to the pallet support rail 402 by one or more bolts, screws, nuts, etc., passing through the apertures 118 and 410. The plate 102 may alternately be coupled with the pallet support rail 402 by alternate means such as welding, insert features, receptor features, etc. A receptor feature may be of either the plate 102 or the pallet support rail 402 such that the receptor feature corresponds with a complementary insert feature of either the pallet support rail 402 or the plate 102, respectively. A receptor feature may be any suitable notch, recess, aperture, opening, etc., while an insert feature may be any suitable member, protrusion, feature, etc. Notably, FIG. 5 shows two pallet stops 100 each coupled to a pallet support rail 402 (each including a first rail 402A and a second rail 402B) and each including five wheels 106A-106C, further including a pallet 502 disposed on top of the pallet support rails 402. FIG. 4 only shows one pallet stop 100 (with two wheels 106) coupled to a pallet support rail 402 (which includes a first rail 402A and a second rail 402B). On the other hand, FIG. 5 shows two pallet stops 100, a first pallet stop 100 being coupled to one pair of first and second pallet support rails 402A and 402B and a second pallet stop 100 coupled to a second pair of first and second pallet support rails 402A and 402B. As seen in FIG. 5, a pallet 502 is disposed such that one side 506 of the pallet 502 is positioned on top of the first pair of the first and second pallet support rails 402A and 402B and another (opposite) side 507 of the pallet 502 is positioned on top of the second pair of the first and second pallet support rails 402A and 402B. Notably, in embodiments with multiple pallet stops 100, each pallet stop 100 may include a different number of wheels 106 and/or include the same number of wheels 106 as the alternate pallet stops 100 (i.e., one pallet stop 100 with five wheels 106 and one pallet stop 100 with two wheels 106).

As described above, the aperture 118 may be disposed on at least one of a first side wall 103 and a second side wall 105 of the plate 102. In some embodiments, each of the first side wall 103 and the second side wall 105 have an aperture 118 disposed proximate the end of the plate 102 opposite the fixed stopper 104, however, any alternate plurality, spacing, and/or configuration of apertures 118 of the plate 102 suitable for coupling the plate 102 of the pallet stop 100 to the pallet support rail 402 of the pallet storage slot 508 may be used. In some embodiments, the pallet support rail 402 includes multiple apertures 410 spaced evenly in a row across the length of the side 406 of the first rail 402A and/or second rail 402B of the pallet support rail 402. There may be any alternate plurality, spacing, and/or configuration of the apertures 410 of the first rail 402A and/or second rail 402B of the pallet support rail 402 suitable for coupling the pallet support rail 402 to the plate 102 of the pallet stop 100.

In the embodiment shown in FIG. 5, each of two pallet support rails 402 of the pallet storage slot 508 includes a first rail 402A and a second rail 402B with a space 402C in-between the first rail 402A and the second rail 402B. The space 402C in-between the first and second rails 402A, 402B is generally the same distance as the distance from the first side wall 103 of the plate 102 to the second side wall 105 of the plate 102 such that the plate 102 of the pallet stop 100 fits into the space 402C of the pallet support rail 402 with a snug fit (e.g., friction fit). In some aspects, the plate 102 of the pallet stop 100 rests between the first rail 402A and the second rail 402B of the pallet support rail 402, and a coupling mechanism (for example, one of the coupling mechanisms described above) couples the exterior surface of the first side wall 103 and the second side wall 105 of the plate 102 to the interior surface of the first rail 402A and to the interior surface of the second rail 402B. In alternate aspects, the pallet stop 100 may be coupled to the pallet support rail 402 of the pallet storage slot 508 by any alternate means including by the interior surface of the first side wall 103 and the second side wall 105 of the plate 102 to the exterior surface of the first rail 402A of the pallet support rail and to the exterior surface of the second rail 402B of a pallet support rail 402, and/or by any other surface or contact points of the pallet stop 100 and the pallet support rail 402.

In some embodiments, the pallet storage slot 508 includes two or more pallet support rails 402 and two or more pallet stops 100. Generally, a pallet storage slot 508 includes a pallet support rail 402 including a first rail 402A and a second rail 402B on either side of the pallet storage slot 508 such that, when a pallet 502 is positioned on two pallet support rails 402, each of the first and second sides 506, 507 of the pallet 502 is generally adjacent to a respective one of the pallet support rails 402. Notably, FIG. 5 depicts two pallet stops 100 coupled with two pallet support rails 402, the first pallet stop 100 being coupled to a first rail 402A and a second rail 402B of a first pallet support rail 402 adjacent to a first side 506 of a pallet 502, and the second pallet stop 100 being coupled to a first rail 402A and a second rail 402B of a second pallet support rail 402 adjacent to a second side 507 of the pallet 502 opposite the first side 506.

In some aspects, a first pallet stop 100 may be coupled with first and second rails 402A and 402B of a first pallet support rail 402, and a second pallet stop 100 may be coupled with first and second rails 402A and 402B of a second pallet support rail 402. The first and second pallet stops 100 and their respective first and second pallet support rails 402 may be spaced apart horizontally such that each side 406 of the first pallet support rail 402 is parallel to and separate from each side 406 of the second pallet support rail 402. In some embodiments, the side 506 of a pallet 502 is parallel with the side 406 of at least one pallet support rail 402. Generally, the pallet stop 100 is attached at or adjacent to the front end 404 of the pallet support rail 402. In some embodiments, before removal of a pallet 502 from the pallet storage slot 508 (i.e., when the pallet 502 is in its catch or resting position), a leading edge 504 of the pallet 502 is generally adjacent to the front end 404 of the pallet support rail 402. While the pallet 502 is being removed from the pallet storage slot 508, the leading edge 504 of the pallet 502 generally leads the pallet 502 in the direction of removal of the pallet 502 from the pallet storage slot 508.

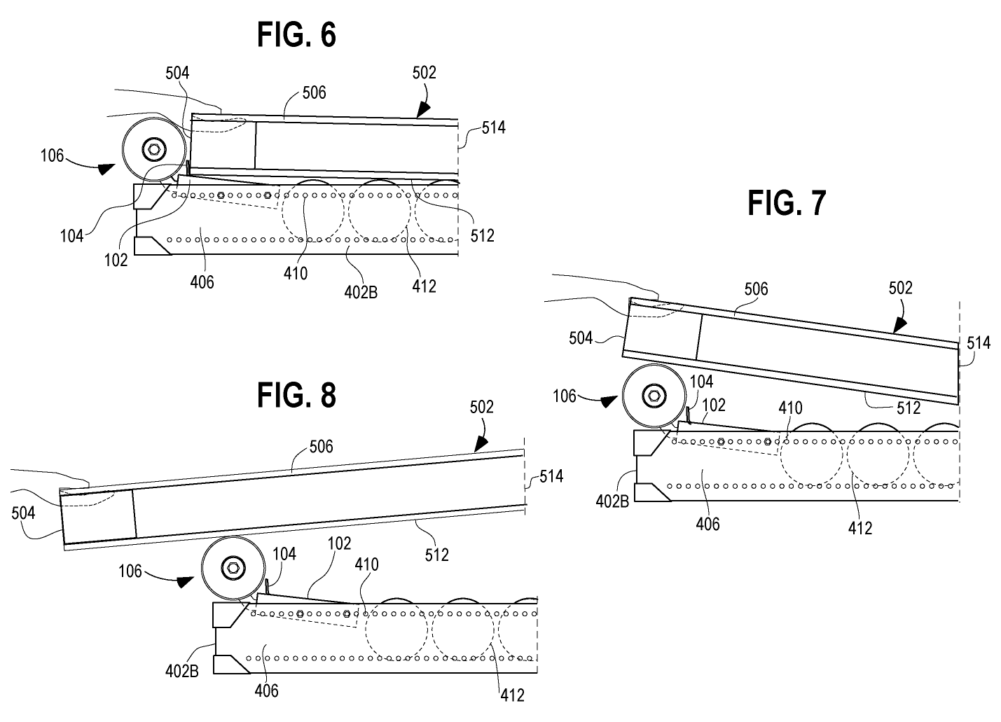

FIGS. 6-10 illustrate a pallet 502 being removed from a pallet storage slot 508. Generally, in order to remove the pallet 502 from the pallet storage slot 508, a worker pulls the pallet 502 away from the pallet storage slot 508, by the leading edge 504 of the pallet 502, in the direction of removal of the pallet 502 from the pallet storage slot 508. In some embodiments, the direction of removal of the pallet 502 is generally away from the pallet storage slot 508 in a direction towards the worker pulling the pallet 502 out of the pallet storage slot 508. FIGS. 6-10 show wheels 412 disposed in the space 402C between the first rail 402A and the second rail 402B generally behind the pallet stop 100 relative to the front end 404 of the pallet support rail 402 in accordance with some embodiments. The wheels 412 may be configured to further assist in the removal of the pallet 502 from the pallet storage slot 508 and are generally found in conventional pallet storage slots 508. In FIG. 6, the pallet 502 is in its resting or catch position on top of the upwardly-facing surface 116 of the plate 102 of at least one pallet stop 100 which is coupled with at least one pallet support rail 402, and portions of the downwardly-facing surface 512 of the pallet 502 are resting on top of the wheels 412 disposed in the space 402C between the first rail 402A and the second rail 402B. In addition, the leading edge 504 of the pallet 502 is in abutment with the fixed stopper 104 of the pallet stop 100. Notably, while FIGS. 6-10 only depict one pallet support rail 402 and one pallet stop 100 disposed on one side 506 of the pallet 502, it will be appreciated that a second side 507 of the pallet 502 may include an additional pallet stop 100 coupled with an additional pallet support rail 402. In the embodiment depicted, the pallet stop 100 includes five wheels 106A-106C as described above.

In FIG. 7, the pallet 502 has been lifted and pulled by the worker such that the leading edge 504 of the pallet 502 has been lifted above and forwardly relative to the top edge 124 of the pallet stop 100, and such that a portion of the downwardly-facing surface 512 of the pallet 502 is positioned above the wheels 412 and disposed on the top surface 120 of the (five) wheels 106 of the pallet stop 100. Notably, the leading edge 504 of the pallet 502 is shown to be higher than a trailing edge 514 of the pallet 502 as the pallet 502 is being removed from the pallet storage slot 508, such that, in some embodiments, the trailing edge 514 of the pallet 502 may be disposed on at least a part (e.g., the wheels 412) of the pallet support rails 402.

In FIG. 8, the worker has continued to pull the pallet 502 away from the pallet storage slot 508 such that a part of the downwardly-facing surface 512 of the pallet 502 distal to the leading edge 504 (and closer to the trailing edge 514) of the pallet 502 is disposed on the wheels 106. Notably, the leading edge 504 of the pallet 502 is shown to be lower than the trailing edge 514 end of the pallet 502 as the pallet 502 is further removed from the pallet storage slot 508, but the leading edge 504 of the pallet 502 may be in any alternate location/configuration during the removal of the pallet 502 from the pallet storage slot 508.

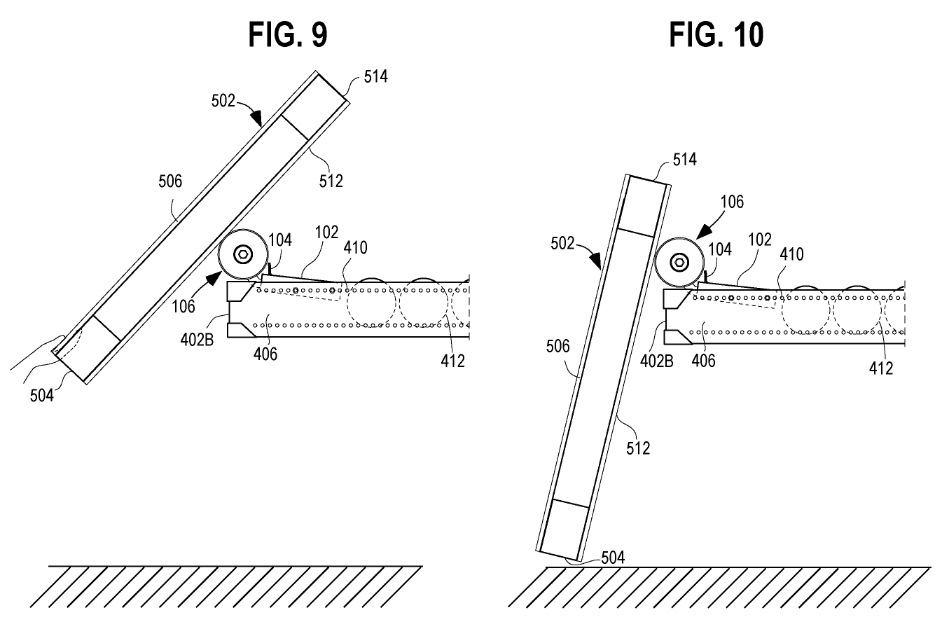

In FIG. 9, the worker has continued to pull the pallet 502 away from the pallet storage slot 508 and the pallet 502 is shown in a position, where the leading edge 504 of the pallet is below the wheels 106 of the pallet stop 100, and the pallet 502 is tilted at an angle of between 45 and 90 degrees relative to the second rail 402B. While the pallet 502 is in the position shown in FIG. 9, the worker may easily support the pallet 502 by hand (i.e., by grasping the pallet 502 by hand near the leading edge 504 of the pallet 502). In other words, despite the pallet 502 being about half-way out of the pallet storage slot 508, the wheels 106 of the pallet stop 100 support a portion of the downwardly-facing surface 512 of the pallet 502 at a location that is between the leading edge 504 of the pallet 502 and the trailing edge 514 of the pallet, thereby providing both a pivot point for the pallet 502 and a support point for the pallet 502.

Generally, by utilizing the pallet stop 100, the worker is able to have increased control over the distance between the leading edge 504 of the pallet 502 and the ground, which permits the worker to control the position of the pallet 502 even as the leading edge 504 of the pallet 502 gets closer to the floor. Without wishing to be limited by theory, the pallet stop 100 is designed to advantageously permit the worker to maintain control of the position and orientation of the pallet 502 as the leading edge 504 of the pallet 502 gets closer relative to the ground during removal of the pallet 502 from the pallet storage slot 508, thereby advantageously decreasing the risk of injury for the worker who is removing the pallet 502 from the pallet storage slot 508.

In FIG. 9 the leading edge 504 of the pallet 502 is further from the wheels 106 of the pallet stop 100 than in FIG. 8, and in FIG. 10, the leading edge 504 of the pallet 502 is further from the wheels 106 of the pallet stop 100 than in FIG. 9 and rests on the ground (i.e., floor).Notably, FIGS. 7-10 depict representative example locations of the pallet 502 during the removal of the pallet 502 from the pallet storage slot 508 by the worker, and it will be appreciated that the pallet 502 may be oriented differently and the leading edge 504 and trailing edge 514 of the pallet 502 may be located at alternate locations relative to the pallet storage slot 508 and the ground during removal of the pallet 502 from the pallet storage slot 508. While FIGS. 6-10 demonstrate the removal of the pallet 502 from the pallet storage slot 508 with the pallet 502 disposed on the pallet stop 100, it will be appreciated that after the pallet 502 is positioned as depicted in FIG. 10, the pallet 502 may be fully removed from the pallet storage slot 508 such that no portion of the pallet 502 is disposed on any part of the pallet storage slot 508 and/or the pallet stop 100.

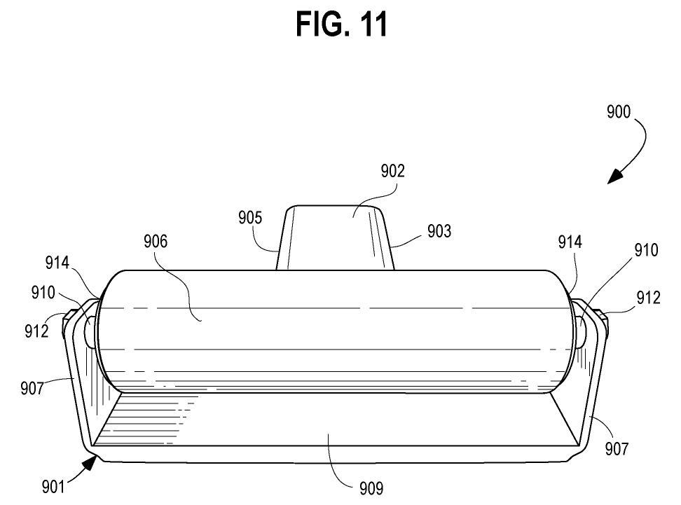

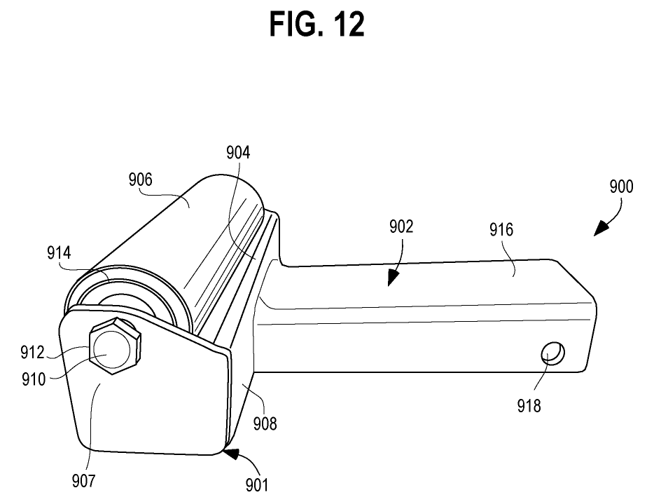

FIGS. 11-12 illustrate a pallet stop 900 according to another embodiment that is configured to catch a portion of a pallet 502 stored in a pallet storage slot 508 at a retail facility to prevent the pallet 502 from inadvertently sliding out of the pallet storage slot 508 and to facilitate removal of the pallet 502 from the pallet storage slot 508. The pallet stop 900 may include components similar to and/or identical to the components of the pallet stop 100 including the plate 102, the fixed stopper 104, the wheels 106, the arms 108, the rod 110, the connectors 112, and/or the bearings 114. In the embodiment depicted in FIGS. 11-12, the pallet stop 900 has exactly one roller wheel 106. The example wheel 106 shown in FIG. 11 is significantly wider than each of the wheels 106A-106C, and generally has a width that is similar to, or greater than, the combined width of the wheels 106A-106C of the pallet stop 100 shown in FIGS. 1-3. Similar to the pallet stop 100, the pallet stop 900 includes a fixed stopper 904 coupled to and extending from the plate 902 of the pallet stop 900. In the illustrated embodiment, the fixed stopper 904 extends outwardly and upwardly relative to the upwardly-facing surface 916 of the plate 102, and is integrally formed with arms 901 such that the arms 901 and the fixed stopper 904 of the pallet stop 900 are one unitary component. In alternate embodiments, the arms 901 and the fixed stopper 904 of the pallet stop 900 may be separate components fixed to each other (detachably or non-detachably). In some aspects, the plate 902, the bearings 914, and the connectors 912 of the pallet stop 900 are identical in construction to the plate 102, the bearing 114, and the connectors 112 of the pallet stop 100.

In the embodiment illustrated in FIGS. 11 and 12, the plate 902 of the pallet stop 900 includes an upwardly-facing surface 916 which is sized and shaped to support a portion of the downwardly-facing surface 512 of a pallet 502 stored within the pallet storage slot 508. While in a catch or rest position on top of the pallet stop 900 prior to removal from the pallet storage slot 508, at least a part of the downwardly-facing surface 512 of the pallet 502 may be disposed on the upwardly-facing surface 916 of the plate 902. In some embodiments, the plate 902 of the pallet stop 900 is non-detachably coupled with the pallet support rail 402. In some embodiments, the plate 902 of the pallet stop 900 is non-detachably coupled with the pallet support rail 402 such that the plate 902 may be removable from the pallet support rail 402 but is intended not to be removed from the pallet support rail 402. In alternate embodiments ,the plate 902 of the pallet stop 900 may be coupled with the pallet support rail 402 and intended to be removable from the pallet support rail 402.

In some embodiments, the pallet stop 900 includes a first side wall 903 extending downwardly from the plate 902 and a second side wall 905 located opposite to the first side wall 903 and extending downwardly from the plate 902. Each of the first side wall 903 and the second side wall 905 may include an aperture 918 that permits the first side wall 903 and the second side wall 905 to be fixedly attached to at least one pallet support rail 402 of a pallet storage slot 508. The aperture 918 may be a threaded or unthreaded hole configured to allow a screw or bolt to pass therethrough and attach the first side wall 903 and the second side wall 905 to a pallet support rail 402, but the aperture 918 may alternately be any other configuration for attaching the pallet stop 900 to the pallet support rail 402. The pallet stop 900 may be fixed to a pallet support rail 402 via the aperture 918 and/or by any alternate suitable means. The first side wall 903 and the second side wall 905 may be formed integrally with the plate 902 of the pallet stop 900 such that the plate 902, the first side wall 903, and the second side wall 905 form a single unitary structure having the upwardly-facing surface 916. In the embodiment depicted in FIGS. 11-12 and further described below, the first side wall 903, the second side wall 905, and the upwardly-facing surface 916 of the plate 902 may further be formed integrally with the arms 901 of the pallet stop 900. Alternatively, the first side wall 903 and/or the second side wall 905 may be additional components fixed to the plate 902 of the pallet stop 900 by any suitable means.

In some embodiments, the bearings 914 of the wheel 906 of the pallet stop 900 may be fixed to either side of the wheel 906 such that the bearings 914 are not permitted to rotate, but such that the wheel 906 is permitted to rotate. The wheel 906 and the bearings 914 may be disposed about a rod 910 that facilitates the rotation of the wheel 906 in the direction of removal of the pallet 502 from the pallet storage slot 508. The arms 901, the bearings 914, and any alternate components of the pallet stop 900 may be unmovably fixed to the rod 910 by any suitable means including welding, force from adjacent components, bolts, etc. In some embodiments, connectors 912 are disposed on opposite ends of the rod 910, and the connectors 912 are configured to limit movement of the wheel 906 about the rod 910 to rotation. In other words, the connectors 912 inhibit movement of the wheel 906 of the pallet stop 900 along the length of the rod 910. The connectors 912 may be any suitable bolt, nut, screw, and/or alternate mechanical connector suitable for fixing the wheel 906 of the pallet stop 900 to prevent movement other than rotation.

In some embodiments, the arms 901 of the pallet stop 900 may be formed as a housing consisting of walls surrounding the wheel 906 of the pallet stop 900, as opposed to the arms 108 which extend between wheels 106 of the pallet stop 100 as depicted in FIGS. 1-3. The arms 901 of the pallet stop 900 may include side walls 907, a bottom wall 909, and a rear wall 908 integrated with the fixed stopper 904. The fixed stopper 904 of the pallet stop 900 and the rear wall 908 of the arms 901 generally extend past the sides of the wheel 906 such that an interior surface of each side wall 907 of the arms 901 is coupled with an exterior side of the wheel 906. The rear wall 908 of the arms 901 intersects (or abuts) and extends upwardly from and is generally perpendicular to the upwardly-facing surface 916 of the plate 902, and the rear wall 908 extends at least across a height of the plate 902 such that the bottom edge of the plate 902 is generally in line with the bottom edge of the rear wall 908 and/or the bottom wall 909 of the arms 901. The ends of the first side wall 903 and the second side wall 905 of the plate 102 may be connected to the rear wall 908 of the arms 901. The bottom wall 909 and the rear wall 908 of the arms 901 are generally connected and perpendicular to each other.

As depicted in FIGS. 11-12, the rear wall 908 and the bottom wall 909 of the arms 901 are generally rectangular and configured to be slightly greater than the width (i.e., the largest dimension) of the wheel 906 in order to house the wheel 906 within the walls 907, 908, and 909 of the arms 901. The side walls 907 are depicted to have the bottom edge of the side wall 907 and the edge of the side wall 907 adjacent to the fixed stopper 904 coupled with the bottom wall 909 and the rear wall 908 of the arms 901, respectively. The edge of each of the side walls 907 opposite the bottom wall 909 of the arms 901, however, is depicted to have a slight curvature that is higher adjacent to the wheel 906 than it is adjacent to the rear wall 908 of the arms 901. Any suitable configuration, shape, length, height, width, etc., of the bottom wall 909, the side walls 907, and/or the rear wall 908 which facilitates the removal of a pallet 502 from a pallet storage slot 508 may be used. Additionally, any means of coupling the plate 902, the first side wall 903 and/or the second side wall 905 of the plate 902, the fixed stopper 904, the arms 901, and/or the bottom wall 909, the side walls 907, and/or the rear wall 908 of the arms 901 including welding, integral formation of the components together, bolts, screws, alternate external hardware attachments, and/or a lack of attachment between some of the mentioned components suitable for facilitating the removal of a pallet 502 from a pallet storage slot 508 may be used.

In some embodiments, the arms 901 of the pallet stop 900 are coupled with and extend outwards from the plate 902, and the bearings 914 coupled with the wheel 906 are coupled with the arms 901 at, for example, the side walls 907. Notably, while FIGS. 11-12 depict the arms 901 as being in the form of a housing for the wheel 906, any alternate configuration of the arms 901, such as arms 901 similar to the arms 108, may be used in order to couple the wheel 906 to the plate 902. In some embodiments, the arm 901 of the pallet stop 900 extends in a direction that is substantially parallel to the direction of removal of the pallet 502 from the pallet storage slot 508. The arm 901 of the pallet stop 900 may, however, extend in any direction and/or with any length of the arm 901 which facilitates the removal of a pallet 502 from a pallet storage slot 508. Generally, in example embodiments, the wheel 906 is positioned proximately (e.g., spaced away by a distance that is less than a diameter of the wheel 906) to the top edge of the rear wall 908 (which functions as the fixed stopper 904) of the arms 901 such that during removal of a pallet 502 from the pallet storage slot 508, the pallet 502 may be easily lifted up and over the top edge of the fixed stopper 904 and placed onto the wheel 906. As mentioned above, positioning the wheel 906 proximately to the fixed stopper 904 reduces the chances that the pallet 502 may get caught between the wheel 906 and the fixed stopper 904 during removal of the pallet 502 from the pallet storage slot 508, and facilitates a smooth transition of the pallet 502 from the resting position on the pallet stop 900 to the position where the pallet 502 is lifted off the pallet stop 900 and fully removed from the pallet storage slot 508.

In some embodiments, the fixed stopper 904 is non-detachably coupled with the plate 902 and extends upwardly from the plate 902. Generally, the fixed stopper 904 is configured to restrict the pallet 502 from unintentionally/inadvertently moving (e.g., sliding) in a direction of removal of the pallet 502 from the pallet storage slot 508, until the pallet 502 is intentionally removed by a worker. In some embodiments, the fixed stopper 904 is oriented perpendicularly relative to the upwardly-facing surface 916 of the plate 902. Notably, the fixed stopper may be angled such that the fixed stopper 904 is not perpendicular to the upwardly-facing surface 116 of the plate 102. In some aspects, the fixed stopper 904 may be generally flat (i.e., planar) and positioned at an angle (90 degrees, less than 90 degrees, or more than 90 degrees) relative to the plate 902. Alternately, the fixed stopper 904 may be curved and may be oriented at multiple angles relative to the upwardly-facing surface 916 of the plate 902.

Any combination of angles, shapes, configurations, and/or curvatures of the fixed stopper 904 relative to the plate 902 which allows the fixed stopper 904 to catch the pallet 502 and restrict directional movement of the pallet 502 from the pallet storage slot 508 and/or which facilitates the removal of a pallet 502 may be used. The fixed stopper 904 may include any combination of materials including metals, plastics, silicones, rubber, wood, etc., able to catch and stop a pallet 502 in a pallet storage slot 508. The fixed stopper 904 of the pallet stop 900 may be fixed to the plate 902 by a plurality of means including soldering, hardware elements, etc., and/or by being formed integrally with the plate 902.

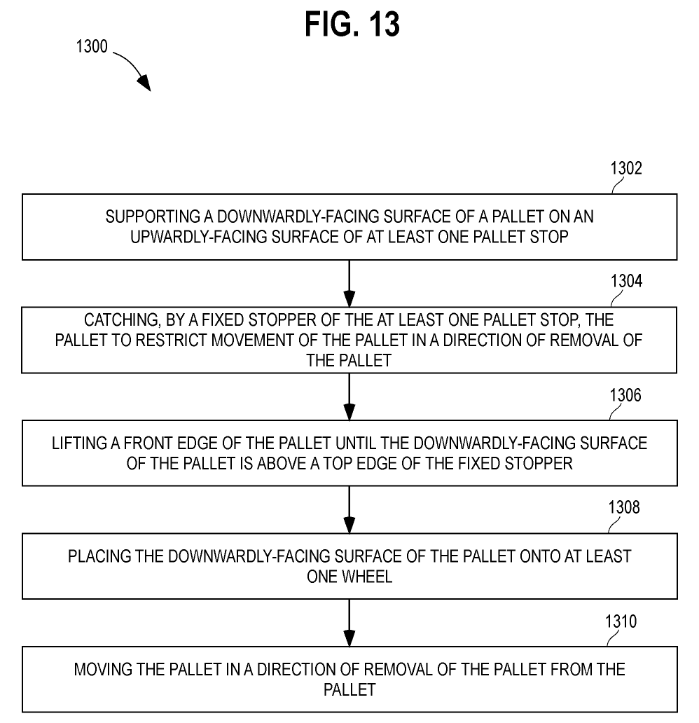

FIG. 13 shows an example method 1300 of removing pallets from a pallet storage slot. It is generally contemplated that the method 1300 may use some or all of the components described above, such as, for example, components of the pallet stop described above. At block 1302, the method 1300 includes an upwardly-facing surface of a plate of a pallet stop supporting a downwardly-facing surface of a pallet. At block 1304, the method 1300 includes the pallet stop catching, by a fixed stopper of the pallet stop, a pallet and restricting the pallet from moving in a direction of removal of the pallet from the pallet storage slot. As mentioned above, in some aspects, the pallet stop is generally coupled with at least one pallet support rail, and includes the plate, the fixed stopper non-detachably coupled with the plate and extending upwardly therefrom, and at least one wheel rotatably coupled relative to the plate and configured to rotate in a direction of removal of the pallet from the pallet storage slot.

At block 1306 of the method 1300, the pallet is removed from the pallet storage slot by lifting a leading edge (which may also be referred to herein as a front edge) of the pallet from the upwardly-facing surface of the plate until the downwardly-facing surface of the pallet is above a top edge of the fixed stopper. Block 1308 of the method 1300 includes placing the downwardly-facing surface of the pallet onto at least one wheel. Block 1310 of the method 1300 includes moving the pallet in the direction of removal of the pallet from the pallet storage slot while the at least one wheel supports the downwardly-facing surface of the pallet thereon. The moving of the pallet may further include rotating the at least one wheel in the direction of removal of the pallet from the pallet storage slot.

Generally, conventional pallet storage slots are located at a distance fairly high (in some instances approximately 5 feet) off of the ground in various retail environments. Pallets are generally quite heavy, and conventional pallet stops often have many catch points with the pallet during removal of a pallet from a pallet storage slot. When a pallet gets caught on a pallet stop during removal of the pallet, a worker needs to lift the heavy pallet above the pallet stop in order to surpass the catch point. These factors all increase the risk of worker injuries during removal of a pallet from a pallet storage slot. In order to reduce potential worker injuries, the example embodiments of the pallet stops described herein utilize wheels to advantageously reduce catch points during removal and to reduce the force needed to pull a pallet out of and away from the pallet storage slot. The wheels advantageously allow pallets to roll smoothly out of the pallet storage slots, and in some embodiments allow a worker to reduce the distance of the leading edge of the pallet to the ground during removal. Additionally, the wheels may advantageously help the trailing edge of the pallet to not get stuck on the pallet stop during removal. It will be appreciated that the example embodiments described above decrease the likelihood of worker injuries during removal of a pallet from a pallet storage slot and facilitate a smoother removal process with less catch points between the pallet stop and the pallet.

As set forth in more detail above, the present application describes improved systems and methods that advantageously both securely restrain pallets within pallet storage slots and facilitate safer, lower-force removal of pallets from such storage slots.

Those skilled in the art will recognize that a wide variety of other modifications, alterations, and combinations can also be made with respect to the above described embodiments without departing from the scope of the disclosure.

What is claimed is:

1. An apparatus for facilitating removal of pallets from a pallet storage slot, the apparatus comprising:
at least one pallet stop coupled to at least one pallet support rail of the pallet storage slot, the at least one pallet stop including:
a plate including an upwardly-facing surface, wherein the upwardly-facing surface supports a downwardly-facing surface of a pallet stored in the pallet storage slot thereon;
a fixed stopper non-detachably coupled to the plate and extending upwardly therefrom, wherein the fixed stopper restricts the pallet from moving in a direction of removal of the pallet from the pallet storage slot; and
at least one wheel rotatably coupled relative to the plate, wherein the at least one wheel rotates in the direction of removal of the pallet from the pallet storage slot;
wherein, during removal of the pallet from the pallet storage slot, the at least one pallet stop permits the downwardly-facing surface of the pallet to be:
lifted therefrom until the downwardly-facing surface of the pallet is above a top edge of the fixed stopper; and
placed onto the at least one wheel and moved in the direction of removal of the pallet from the pallet storage slot while the at least one wheel supports the downwardly-facing surface of the pallet thereon and rotates in the direction of removal of the pallet from the pallet storage slot.

2. The apparatus of claim 1, wherein the plate is non-detachably coupled to the at least one pallet support rail.

3. The apparatus of claim 1,
wherein the at least one pallet support rail includes two or more support rails and the at least one pallet stop includes two or more pallet stops; and
wherein a first pallet stop of the two or more pallet stops is coupled to a first support rail of the two or more support rails, and a second pallet stop of the two or more pallet stops is coupled to a second support rail of the two or more support rails.

4. The apparatus of claim 1, wherein the at least one wheel is directly coupled to the plate.

5. The apparatus of claim 1, wherein the at least one wheel is a caster wheel.

6. The apparatus of claim 1, wherein the at least one wheel consists of one roller wheel.

7. The apparatus of claim 1,
wherein the at least one pallet stop further comprises at least one arm coupled to and extending outwards from the plate; and
wherein the at least one wheel is coupled to the at least one arm.

8. The apparatus of claim 7, wherein the at least one arm extends in a direction that is substantially parallel to the direction of removal of the pallet from the pallet storage slot.

9. The apparatus of claim 7, further including a rod coupled to the at least one arm;
wherein the rod extends in a direction that is substantially perpendicular to the direction of removal of the pallet from the pallet storage slot; and
wherein the at least one wheel rotates about the rod in the direction of removal of the pallet from the pallet storage slot.

10. The apparatus of claim 9, wherein at least one connector is disposed on opposite ends of the rod, and the at least one connector limits movement of the at least one wheel about the rod to rotation.

11. The apparatus of claim 1, wherein the at least one wheel includes three or more wheels, and the three or more wheels include:
a first end wheel;
a second end wheel; and
one or more middle wheels disposed between the first end wheel and the second end wheel.

12. The apparatus of claim 11, wherein each of the three or more wheels includes a bearing, and the bearing of each of the three or more wheels is coupled to the bearing of at least one adjacent wheel of the three or more wheels.

13. The apparatus of claim 11,
wherein each of the three or more wheels includes a first side and a second side;
wherein each of the one or more middle wheels is coupled by a respective bearing to an adjacent wheel of the three or more wheels on the first side and the second side; and
wherein the first end wheel is coupled by the respective bearing to a first wheel of the one or more middle wheels on the respective first side, and the second end wheel is coupled by the respective bearing to a second wheel of the one or more middle wheels on the respective second side.

14. The apparatus of claim 11,
wherein the three or more wheels are identical in size;
wherein the three or more wheels are oriented such that top surfaces of the three or more wheels are co-linear to one another; and
wherein bottom surfaces of the three or more wheels are co-linear to one another.

15. The apparatus of claim 1, wherein the at least one wheel is positioned relative to the plate such that a top surface of the at least one wheel is higher than the top edge of the fixed stopper relative to the upwardly-facing surface of the plate.

16. The apparatus of claim 1, wherein the fixed stopper is oriented perpendicularly relative to the upwardly-facing surface of the plate.

17. The apparatus of claim 1, wherein the fixed stopper is angled such that the fixed stopper is not perpendicular to the upwardly-facing surface of the plate.

18. The apparatus of claim 1,
wherein the at least one pallet stop includes a first side wall extending downwardly from the plate and a second side wall spaced apart from and opposite to the first side wall and extending downwardly from the plate; and
wherein each of the first and second side walls includes an aperture that permits the first and second side walls to be fixedly attached to the at least one pallet support rail of the pallet storage slot.

19. A method for removing pallets from a pallet storage slot, the method comprising:
supporting a downwardly-facing surface of a pallet on an upwardly-facing surface of a plate of at least one pallet stop while catching, by a fixed stopper of the at least one pallet stop, the pallet to restrict the pallet from moving in a direction of removal of the pallet from the pallet storage slot, wherein the at least one pallet stop is coupled to at least one pallet support rail of the pallet storage slot, the at least one pallet stop including:
the plate;
the fixed stopper non-detachably coupled to the plate and extending upwardly therefrom; and
at least one wheel rotatably coupled relative to the plate, wherein the at least one wheel rotates in the direction of removal of the pallet from the pallet storage slot;
lifting a front edge of the pallet from the upwardly-facing surface of the plate until the downwardly-facing surface of the pallet is above a top edge of the fixed stopper;
placing the downwardly-facing surface of the pallet onto the at least one wheel; and
moving the pallet in the direction of removal of the pallet from the pallet storage slot while the at least one wheel supports the downwardly-facing surface of the pallet thereon.

20. The method of claim 19, wherein the moving of the pallet further comprises rotating the at least one wheel in the direction of removal of the pallet from the pallet storage slot.
